(19) United States
(12) Patent Application Publication
(10) Pub. No.: US 2009/0030779 A1
(43) Pub. Date: Jan. 29, 2009

(54) Electronic coupon filtering and delivery

(76) Inventors: Preston Tollinger, Los Altos, CA (US); Brent Dusing, San Jose, CA (US)

Correspondence Address: NIXON PEABODY, LLP, 401 9TH STREET, NW, SUITE 900, WASHINGTON, DC, 20004-2128, US

(21) Appl. No.: 12/212,530

(22) Filed: Sep. 17, 2008

Related U.S. Application Data
(63) Continuation-in-part of application No. 11/349,037, filed on Feb. 6, 2006.
(60) Provisional application No. 60/650,363, filed on Feb. 4, 2005.

(51) Int. Cl. G06Q 30/00; G06F 17/00

(52) U.S. Cl. 705/10; 705/14; 701/300

(57) ABSTRACT

A method of delivering coupons to a user/client at a portable device. The method includes determining memory space available on the device for storing coupons, each coupon being associated with a merchant. A set of coupons that each fit the available memory space is determined and ranked in order based on a scoring of the associated merchant. A subset of the set of coupons are delivered to the portable device; the subset fitting the available memory space based on the coupon ranking order, which in turn is based on the associated merchant's scoring. The scoring is preferably based on filter criteria which may include demographic, location of device, and other information, and combinations thereof. Coupon ranking is alternatively based on data sources external to the portable device like merchant or retailer databases.

### CROSS-REFERENCE TO RELATED APPLICATION

This application is a continuation in part of U.S. application Ser. No. 11/349,037, filed Feb. 6, 2006, which claims the benefit of U.S. Provisional Application No. 60/650,363, filed Feb. 4, 2005; which applications are fully incorporated by reference herein.

### FIELD OF THE INVENTION

This invention relates generally to methods associated with portable devices, and more particularly to methods associated with portable devices to deliver target advertising:

### BACKGROUND

One way general advertising on portable devices is delivered is as Short Message Service (SMS) or text messages. The advertising may be in the form of coupon text information. These messages can only contain plain text and are delivered to an SMS inbox provided by most portable devices. The inbox is a general inbox that contains all messages received by that device from any source. There is no ability to track which advertisements or coupons among the messages in the general inbox are read or deleted; or, in fact, any confirmation that the user even looked into the SMS inbox.

Advertising is also delivered as part of streaming video (i.e. TV) on some mobile devices. This streaming video type of advertising acts like current TV advertising in that it interrupts the content with the advertisement and there's no ability to target different ads to different demographics or any way to interact with the advertising.

Coupons available on a portable device can provide substantial increased utilization compared to their paper counterparts. It is desirable to provide a user of a portable device with coupons most relevant for the particular user. Merchants also seek to target coupons more specifically to consumers. Portable devices have limited memory capacity for storing coupons or advertising. What is needed, therefore, is a method for delivering targeted coupons to portable devices that have limited memory capacity for storing coupons. What is needed, more specifically, is a method for delivering coupons to a portable device, where all available coupons are filtered to rank them based on certain criteria, with only a subset of the coupons that fit the available space on the user's portable device being delivered to the user based on the ranking.

### SUMMARY

Broadly stated, the present invention provides, a method for delivering coupons to a portable device comprising determining memory space available on the portable device for storing plural coupons, each coupon being associated with a merchant; determining a set of coupons that each fit the available memory space; ranking the set of coupons in order based on a scoring of the associated merchant; and delivering a subset of the set of coupons to the portable device of a user, wherein the subset fits the available memory space based on the coupon ranking order.

An advantage of the present invention is that it provides a method for delivery of a subset of coupons to the user's portable device that considers the memory space limitations of the portable device while providing the subset in an order based on scoring of the merchant associated with each coupon.

Another advantage of some embodiments of the present invention is that the merchant's scoring is based on a number of filter criteria.

An additional advantage of some embodiments of the present invention is that the ranking of the coupons is based on data sources external to the portable device or its user such as merchant or retailer databases.

These and other embodiments, features, aspects, and advantages of the invention will become better understood with reference to the following description, appended claims and accompanying drawings.

### BRIEF DESCRIPTION OF THE DRAWINGS

FIG. 1 illustrates an embodiment of the method of delivering coupons to a portable device of the present invention;

FIG. 2 is a table that illustrates an example of the weighting, shown as a percentage, for three merchants and two filter criteria, according to an exemplary embodiment of the present invention;

FIG. 3a and FIG. 3b illustrate a determination of a normalized score for certain filter criteria #1 and #2, respectively, in FIG. 2; and

FIG. 4 is a table illustrating an exemplary determination of weighted normalized scores for each filter criteria for each merchant, and the total scores for each merchant.

Reference symbols or names are used in the Figures to indicate certain components, aspects or features shown therein, with reference symbols common to more than one Figure indicating like components, aspects or features shown therein.

### DETAILED DESCRIPTION

The method of the present invention is for delivering coupons or other advertising items to a portable device. The coupons or other advertising items are referred to herein collectively as “coupons”. Preferably, the coupons are downloaded from a host server to a portable device of a user, also referred to herein as a client. The client's device information, relative to the client's portable device, is received at the host server. Suitable portable devices include, but are not limited to, cell phone, personal digital assistants (PDAs), smart devices, personal portable devices and the like.

A determination is made, from the client's device information, the model or version of the client's portable device. In response to the determination, a client ID is preferably embedded in the client's portable device and a client software application is delivered from the host server to the client's portable device. The client software application is used for downloading coupons relative to a product or service; the coupons being delivered from the host server to the client's portable device. The downloading of the application can be implemented over a network connection, downloaded via a cable or over a Bluetooth connection. The application may be downloaded from the host computer as described in U.S. application Ser. Nos. 11/349,037 and 11/349,050, incorporated by reference herein. Alternatively, the application can be preinstalled on the phone by the manufacturer or distributor, and the like.

By way of illustration, and without limitation, the client software can be written in J2ME (Java2 Portable Edition), be ported to Symbian, BREW, Palm OS and .NET for windows CE, and the like. In addition as new portable device operating systems and development languages evolve the client software can be easily ported to them as well. By way of illustration, and without limitation, the J2ME application can installed onto a cell phone by sending an SMS message to the phone with a download link. The client selects the link and then automatically installs the software. However, the URL can also be entered by hand in the device's web browser or the software could be transferred to the device over some other download means including, but not limited to, a cable.

The user is preferably prompted for certain client personalized information. Such personal information can include, but it not limited to the client's, zip code, age, gender, address, contact information, preferences, and the like. Alternatively, this information may also be obtained from an authorized external data source, e.g., a user's loyalty card provider to which the user has provided personal information.

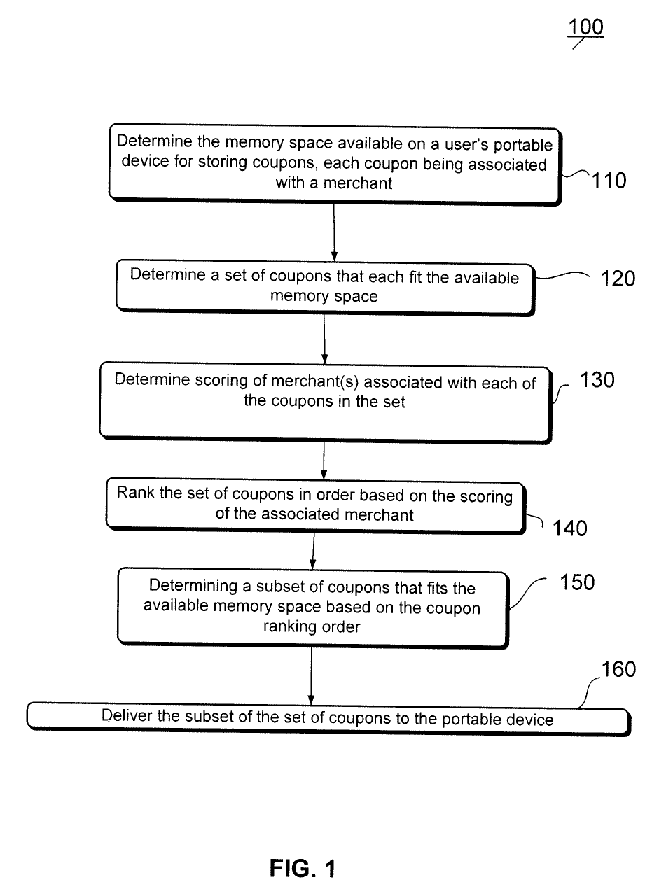

FIG. 1 illustrates an embodiment 100 of the method of delivering coupons to a portable device of the present invention. In Step 110, a determination is made of the memory space available on the portable device for storing coupons. The amount of memory provided in portable devices varies considerably. For portable cellular telephones, for example, the amount of memory space varies not only among manufacturers, but also among different models from the same manufacturer. Consequently, the host computer that provides for downloading of coupons to the portable device, according to the present invention, has information regarding the limitations of each portable device/model combination in order to determine the memory space available for coupons for a particular portable device.

In addition to determining the portable device's available memory space in Step 110, the method of the present invention in FIG. 1 includes, in Step 120, determining a set of coupons that each fit that available space. Each of the coupons is associated with a merchant, who in turn is associated with one or more coupons. In Step 130, a determination is made of scoring of the merchants associated with each of the coupons in the set of coupons that was determined in Step 120. In Step 140, a ranking is made of the set of coupons in order based on a scoring of the associated merchant. In Step 150, a determination is made of a subset of coupons that fits the portable device's available memory space based on the coupon ranking order from Step 140. In Step 160, the subset of the set of coupons is delivered to the portable device. Delivery is preferably via a wireless protocol suitable for the portable device.

The ranking of Step 240 is thus used in combination with the determination of portable device's available memory space for determining a subset of coupons to deliver to the portable device. The ranking is based on the scoring of the merchant that is associated with each of the coupons of the set of coupons that fits the available space in the portable device. The set of coupons are ranked in order based on the merchant's score.

According to a preferred embodiment, the scoring of the associated merchant is based on certain filter criteria. One filter criteria used according to an embodiment of the present invention is the history of the coupons previously delivered to the portable device. This historical data is maintained at the host computer in order to enable application of the history-based filter criteria. If the history-based filter criteria for a particular merchant indicates that the merchant's coupons have previously been delivered to the user's portable device, the score for that particular merchant is preferably adjusted. According to one embodiment, a merchant whose coupons have not previously been delivered to the user's portable device, everything else being equal, would be given a higher score than another merchant whose coupons had been delivered. Alternatively, a higher score would be given for a merchant whose coupon had previously been delivered to the user's portable device.

Another filter criteria on which scoring of a merchant is based, according to an embodiment of the present invention, is whether any previously delivered coupons for a merchant were actually used by the user. This “prior use” related filter criteria includes determining coupons that the user of the portable device has used for a purchase. Preferably, a merchant's score associated with the prior use filter criteria is adjusted if the user of the portable device has previously used one or more of the merchants delivered coupons, e.g., increase score to provide a loyalty-type award, or decrease score if the merchant's aim is to attract new customers through the coupon offer.

According to some embodiments of the present invention, a determination is made as to which coupons the user of the portable device has viewed on that device, i.e., the coupon viewing pattern. Based on the determination, one or more of the filter criteria is based on the user's coupon viewing pattern. Merchants may be associated with a number of brands of products and/or services and with one or more coupons. The merchant's score with regard to the viewing pattern based filter criteria is preferably decreased if the user hasn't viewed any coupons for a brand associated with the merchant.

According to another embodiment of the present invention, one or more filter criteria are based on a relative preference between merchants. The preference may be for business reasons. Some merchant's coupons are more popular than others. Coupons of more popular merchants might be more or less valuable to the user of the portable device. For business reasons, there may be reasons to reward a more popular merchant with a higher score, or, alternatively, to help out a less popular merchant by boosting their score. For the relative preference filter criteria, the merchant's score scoring is increased or decreased relative to other merchants based on the merchant's popularity or relative popularity.

One or more filter criteria are based on demographic information received from the user of the portable device, according to an embodiment of the present invention. The demographic information is based on certain user personalized information including, but not limited to, the portable device user's zip code, age, gender, address, contact information, preferences, and the like. The demographic data is preferably provided by the user prior to the downloading of the application. Alternatively, the application may prompt for demographic information.

The filter criteria based on the age of the user may alternatively be divided into several age groups, or age buckets, e.g., under 18 years of age, 18-24, 25-34, 35-44, 45 and above, to provide filter criteria for targeting coupons or other advertising items at particular age groups.

The filter criteria based on the address of the user's residence and/or business is preferably based on the distance from the coupon merchant's location to the user's address. The address of the user is alternatively determined using data from at least one source that is remote from both the portable device and the user. An exemplary remote source is a database associated with at least one of the merchants. The database associated with at least one of the predetermined retailers is another exemplary remote source.

Another filter criteria on which scoring of a merchant is based, according to an embodiment of the present invention, is based the location of the portable device. For this portable device location filter criteria, the present invention preferably looks for location-based information, including, but not limited to, GPS coordinates, received data from Bluetooth transmitters, an IP address assigned from a wireless or wired internet connection from which the location can be calculated, or other data. The location-based information is then converted into a street address and stored along with the an accuracy range (where the GPS coordinates might give a three meter range, a Bluetooth message a 3 foot range and an IP address lookup might allow for a 1 mile radius or more). A zip code may also be determined based on the determined street address. In the case of the GPS coordinates, a map lookup will give a street address. For the Bluetooth transmitted information, the location of the transmitter must already be known. For wired connections, the closest router or server can be determined by tracking the path that packets take and based on the location of that server and the delay for the packets to get from the client to that server, a location can be calculated. For wireless cell phone connections, for example, the location of the base station to which the client is connecting can be looked up. According to one embodiment, a filter criteria based on the location of the portable device takes the form of distance from the coupon's associated merchant location to the nearest zip code associated with the location information for the user portable device

Preferably, more than one filter criteria are combined in order to determine the scoring, e.g., combine user's age, distance to the merchant, and business preference. Each of the filter criteria has a predetermined weight. The scoring based on filter criteria includes determining the weighting that each filter criteria will have on the scoring for each merchant. The method of the present invention enables other filter criteria to be added. For example, the method enables the addition of filter criteria based on additional information becoming available. For example, additional information may become available from new sources or additional detail from existing sources, e.g., regarding the location of the device, address of the user, viewing and purchasing history, etc., from which filter criteria are based.

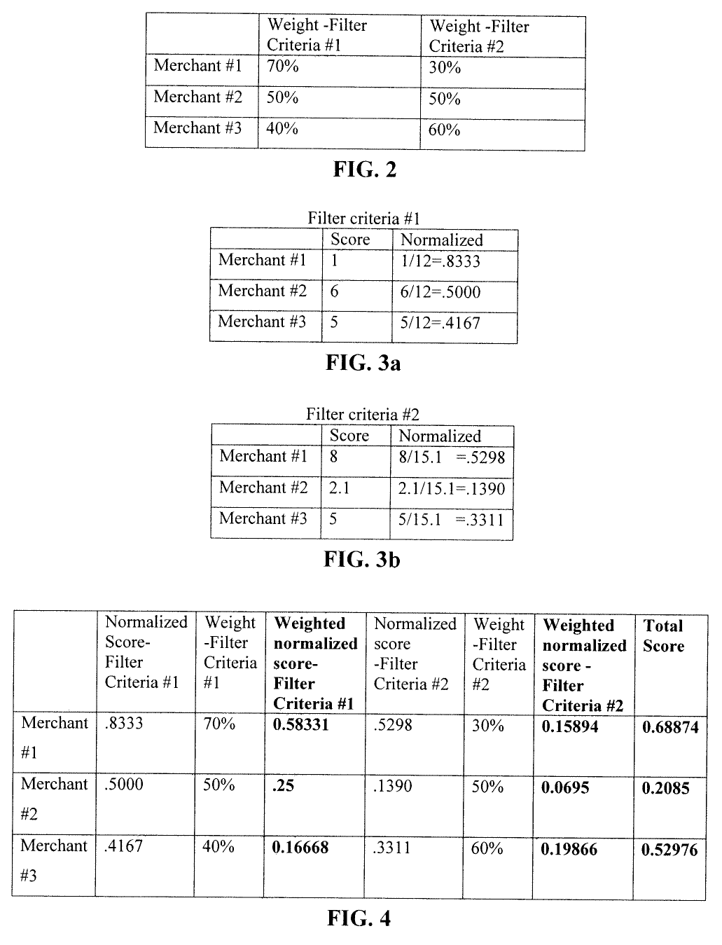

FIG. 2 is a table that illustrates an example of the weighting, shown as a percentage, for three merchants and two filter criteria. The table in FIG. 2 is exemplary; the present invention is not so limited in the number of merchants or filter criteria. In the example in FIG. 2, for Merchant #1: filter criteria #1 has a weighting of 70% and filter criteria #2 has a weighting of 30%. For Merchant #1: filter criteria #1 and #2 both have a weighting of 50%. For Merchant #3: filter criteria #1 has a weighting of 40% and filter criteria #2 has a weighting of 60%. Preferably, the sum of the weightings equals one hundred percent, as is the case in the example in FIG. 2.

According to a preferred embodiment of the present invention, the scoring further includes the step of determining a score for each merchant for each filter criteria. The merchant scores for each merchant are preferably normalized, where the normalized score is obtained by dividing each score by the sum of the scores. Alternatively, the scores are not normalized.

FIG. 3a and FIG. 3b illustrate for filter criteria #1 and #2, respectively, in FIG. 2 a determination of a normalized score. In the example is FIG. 3a, Merchant #1 has a score of 1, Merchant #1 has a score of 6, and Merchant #3 has a score of 5, for the filter criteria #1. The normalized score is obtained by dividing each score by the sum of the scores, e.g., the normalized value for Merchant #1 for filter criteria #1 is 1/12=0.8333. The normalized scores are shown to four decimal places for the example; the normalized scores need not be so limited for the invention. FIG. 3b shows scores and normalized scores for filter criteria #2 for the three merchants.

According to a preferred embodiment of the present invention, the scoring further includes applying the weighting of each filter criteria for each merchant to the corresponding merchant's score for the filter criteria. FIG. 4 is a table illustrating an exemplary determination of weighted normalized scores for each filter criteria for each merchant, and the total scores for each merchant. The weighting of each filter criteria have been applied to the normalized score for each filter criteria for each merchant, with the resulting weighted normalized scores shown. For example, the weighting of 70%, i.e., 0.70 was applied to the normalized score of 0.8333 for filter criteria #1 for Merchant #1, resulting in a weighted normalized score of 0.58331 for filter criteria #1 for Merchant #1. The weightings are applied for each of the normalized scores with the results as shown in FIG. 4 for the example in FIGS. 2-3b.

The scoring further includes determining a total score for each merchant by summing the corresponding weighted merchant's score for each filter criteria. Preferably, the scores are normalized, e.g., by dividing each score by the sum of the scores. In the example in FIG. 4, the total score on the far right column is the sum of the weighted normalized scores.

Products or services of a merchant associated with one of the coupons might be available for purchase only through one or more predetermined retailers. In that instance, the ranking of a coupon associated with a merchant is preferably based on data obtained from the predetermined retailers from whom the user has made a purchase, according to one embodiment of the method of the present invention.

Having disclosed exemplary embodiments, modifications and variations may be made to the disclosed embodiments while remaining within the scope of the invention as described by the following claims.

What is claimed is:

1. A method for delivering coupons to a portable device comprising:
determining memory space available on the portable device for storing plural coupons, each coupon being associated with a merchant;
determining a set of coupons that each fit the available memory space;
ranking the set of coupons in order based on a scoring of the associated merchant; and
delivering a subset of the set of coupons to the portable device of a user, wherein the subset fits the available memory space based on the coupon ranking order.

2. The method of claim 1, wherein the scoring of the associated merchant is based on a plurality of filter criteria.

3. The method of claim 2, wherein the scoring comprises:
determining a weighting that each filter criteria will have on the scoring for each merchant; determining a score for each merchant for each filter criteria;
applying the weighting of each filter criteria for each merchant to the corresponding merchant's score for the filter criteria; and
determining a total score for each merchant by summing the corresponding weighted merchant's score for each filter criteria.

4. The method of claim 3, wherein the sum of the weightings for each merchant totals one hundred percent.

5. The method of claim 3, wherein the merchant scores for each filter criteria are normalized.

6. The method of claim 1, wherein each merchant is associated with one or more coupons.

7. The method of claim 1, wherein delivery is via a wireless protocol.

8. The method of claim 2, further comprising determining the location of the portable device and wherein one of the filter criteria is the distance from the merchant's location to the location of the portable device.

9. The method of claim 2, wherein one or more of the filter criteria are based on demographic information received from the user of the portable device.

10. The method of claim 2, wherein the demographic information includes age and one of filter criteria is the user's age.

11. The method of claim 2, wherein one or more of the filter criteria are based on a history of the coupons previously delivered to the portable device.

12. The method of claim 11, wherein the score for each merchant is adjusted if the merchant's coupons have previously been delivered to the portable device.

13. The method of claim 2, further comprising determining coupons that the user of the portable device has used for a purchase.

14. The method of claim 13, wherein one or more of the filter criteria are based on prior use by the user of coupons of the merchant delivered to the portable device, wherein the corresponding filter criteria score is increased if the user has previously used one or more of a merchant's coupons.

15. The method of claim 2, further comprising determining which coupons the user of the portable device has viewed on the portable device.

16. The method of claim 15, wherein one or more of the filter criteria are based on the user's coupon viewing pattern.

17. The method of claim 16, wherein the score for the viewing pattern based filter criteria is decreased if the user has not viewed any coupons for a brand associated with the merchant.

18. The method of claim 2, wherein one or more of the filter criteria are based on a relative preference between merchants.

19. The method of claim 18, wherein a merchant's score for the relative merchant preference based criteria is increased or decreased relative to other merchants based on the merchant's popularity.

20. The method of claim 3, wherein the plurality of filter criteria comprise:
one or more criteria based on the distance from the merchant's location to the location of the portable device;
one or more criteria based on the age of the user of the portable device;
one or more criteria based on a history of the coupons previously delivered to the portable device;
one or more criteria based on prior usage of delivered coupons by the user of the portable device;
one or more criteria based on the user's coupon viewing pattern; and
one or more of the filter criteria based on a relative preference between merchants.

21. The method of claim 2, further comprising determining an address of the user of the portable device, and wherein one or more of the filter criteria is based on the user's address.

22. The method of claim 21, wherein one or more of the filter criteria is based on the distance from the merchant's location to the user's address.

23. The method of claim 21, wherein determining the address includes using data from at least one source remote from both the portable device and the user.

24. The method of claim 23, wherein the remote source comprises a database associated with at least one of the merchants.

25. The method of claim 1, wherein at least one of the coupons is redeemable only at one or more retailers predetermined by the associated merchant.

26. The method of claim 25, further comprising determining the location of the portable device, wherein the ranking is based on the distance from the predetermined retailer's location to the location of the portable device.

27. The method of claim 25, further comprising determining the address of the user of the portable device.

28. The method of claim 27, wherein the ranking is a function of distance from the address to the predetermined retailer's location.

29. The method of claim 27, wherein determining the address of the user is based on data received from the user of the portable device.

30. The method of claim 27, wherein determining the address of the user includes using data from at least one source remote from both the portable device and the user.

31. The method of claim 30, wherein the remote source comprises a database.

32. The method of claim 31, wherein the database is associated with at least one of the merchants.

33. The method of claim 33, wherein the database is associated with at least one of the predetermined retailers.

34. The method of claim 1, wherein products or services of a merchant associated with one of the coupons are available for purchase only through one or more predetermined retailers, wherein the ranking for the associated coupon is based on data obtained from predetermined retailers from whom the user has made a purchase.
